(19) United States
(12) Patent Application Publication
(10) Pub. No.: US 2005/0080879 A1
(43) Pub. Date: Apr. 14, 2005

(54) Home network system and method for operating the same

(75) Inventors: Chang Ho Kim, Seoul (KR); Hyung Taik Im, Kyungki-do (KR)

Correspondence Address: JONATHAN Y. KANG, ESQ.;LEE, HONG, DEGERMAN, KANG & SCHMADEKA, 14th Street, 801 S. Figueroa Street, Los Angeles, CA, 90017, US

(73) Assignee: LG Electronics Inc.

(21) Appl. No.: 10/875,745

(22) Filed: Jun. 23, 2004

(30) Foreign Application Priority Data
Oct. 9, 2003 (KR) 2003-70319

(51) Int. Cl. G06F 15/16

(52) U.S. Cl. 709/219

(57) ABSTRACT

A home network system includes a home server for controlling a network in a residence and a portal serve for managing the home server. The portal server is connected to the home server over the Internet, and the home server controls operations of one or more electric appliances connected to the network. The home server communicates data with the portal server to perform automatic upgrade of software installed on the home server. This automatic upgrade allows the home server to maintain the latest version of the software installed on the home server without requiring an annoying manual operation, thereby improving user convenience and increasing system stability.

### BACKGROUND OF THE INVENTION

1. Field of the Invention

The present invention relates to a home network system that can perform mutual control of a plurality of electric appliances connected to a network installed in a building, and more particularly to a home network system, wherein an upgrade execution module for performing version management of software installed on a home server is provided, and wherein if an electric appliance is newly or additionally connected to a network or if upgraded software is released, the home server communicates data with a portal server over the Internet to automatically upgrade the software installed on the home server, thereby improving the convenience of users.

2. Description of the Related Art

A home network system is an integrated system in which a plurality of electric appliances including a Personal Computer (PC) are connected to a network installed in a building, and the electric appliances communicate with each other to enable state monitoring or operation control of the appliances.

FIG. 1 shows the configuration of such a general home network system. To accomplish such a home network system, it is required to provide networkable electric appliances h1 to h4, and a home server 30 capable of performing central processing, such as state change monitoring, network connection state detection and operation control, of the electric appliances h1 to h4, as shown in FIG. 1.

An internal or external network modem (not shown) is connected to each of the electric appliances h1 to h4 for allowing it to transmit or receive signals over a network N.

Each of the electric appliances h1 to h4 includes an embedded microcomputer (not shown) that allows it to perform an operation corresponding to a control signal it receives over the network N or according to a control command which is manually input to it from the outside. The microcomputers enable the electric appliances h1 to h4 to perform mutual operation control using control signals transmitted or received through the network modems installed in them.

The microcomputer performs a control operation corresponding to a control signal received over the network N, and generates a control result message for notification of the result of the control operation and transmits the generated control result message to the home server 30.

The home server 30 is equipment that is capable of detecting connection states of the electric appliances h1 to h4 connected to the network N and controlling detailed operations thereof by controlling the flow of signals communicated over the network N.

To accomplish this, the home server 30 includes an input unit for allowing a user to input a control command, and an output unit for allowing the user to confirm the result of an operation control corresponding to the control command. The microcomputer is provided with a Graphic User Interface (GUI) for facilitating input/output operations of the user.

The home server 30 also includes a network card or a network modem for allowing the home server 30 to be connected with an external portal server 40 over the Internet.

By operating a remote control unit 50 to connect to the portal server 40, an external user can confirm a network connection state of an electric appliance in a residence or can input a control command for controlling an operation thereof. The portal server 40 is a server that communicates data with home servers 30 of a plurality of residences, thereby enabling remote control of the home servers 30.

To improve the convenience of users, the home server 30 is installed with an Operating System (OS) and various other software for registration management of electric appliances, registration management of personal information, a telephone book, a memo, a household account book or the like.

In the prior art, to perform initial installation of such software, the user connects to each of the corresponding software provider sites and purchases or downloads each of the software. To upgrade software after the installation thereof, the user must individually search for and download the latest version of the software, which makes software management quite troublesome.

The user selects whether to upgrade the version of installed software, and then manually performs a series of processes for downloading the latest version of the installed software. Thus, it takes too long to install the latest version of the software.

If the OS of the home server has not been upgraded to the latest version, the home server cannot normally communicate signals with a newly launched electric appliance connected to the network and cannot detect the connection thereof. If security management software has not been upgraded, new worms may cause the entire system to shut down, lowering the reliability of the home network system.

For users having poor computer skills, it is not easy to search for or download software to be installed or upgraded, and they mostly request A/S with additional costs, which increases the burden of paying management costs of the home network system.

### SUMMARY OF THE INVENTION

Therefore, the present invention has been made in view of the above problems, and it is an object of the present invention to provide a home network system and a method for operating the same in which a home server and a portal server perform mutual data communication allowing the home server to automatically download and install the latest version of software, thereby improving user convenience.

It is another object of the present invention to provide a home network system and a method for operating the same in which security management software is always kept up to date to prevent system malfunction due to viruses, thereby improving the reliability of the home network system.

In accordance with one aspect of the present invention, the above and other objects can be accomplished by the provision of a home network system comprising a plurality of electric appliances connected to a network provided in a building; a portal server provided to allow the plurality of electric appliances to be remotely controlled from a remote site over the Internet; and a home server for performing plug-in processing of an electric appliance newly connected to the network and communicating data with the portal server, thereby automatically performing software version upgrade.

In accordance with another aspect of the present invention, there is provided a method for operating a home network system, comprising the steps of a) allowing an electric appliance to be plugged in a network provided in a building; b) by a home server, transmitting product information of the plugged-in electric appliance to a portal server, said home server controlling the network; c) by the portal server, receiving the product information and transmitting software for controlling the electric appliance to the home server; and d) by the home server, downloading and installing the software, thereby performing automatic software upgrade.

In accordance with yet another aspect of the present invention, there is provided a method for operating a home network system, comprising the steps of a) transmitting a version information request message to a portal server as a home server operates, said message requesting information of a latest version of home server software; b) by the portal server, transmitting the information of the latest version to the home server after receiving the version information request message; and c) performing automatic upgrade of software installed in the home server if the latest version is greater than a version of the software installed in the home server.

The home network system is a system for controlling one or more electric appliances over a network established in a building. The network is connected with a home server for performing active control and server functions and with one or more electric appliances that operate according to control signals issued by the home server or manually operate according to control commands input to the electric appliances.

It should be noted that the network may be a wired LAN, a wireless LAN or a power line, but the type of the network is not limited thereto, and the type of the electric appliances is also not limited to that of the electric appliances h1 to h4 illustrated in the figures.

Each of the electric appliances includes a network modem for allowing it to transmit and receive signals over the network, and includes a microcomputer for allowing it to perform operations according to control signals received over the network or according to control commands input to it.

The home server detects the flow of signals transmitted and received over the network and monitors states of one or more electric appliances connected to the network. To accomplish this, the home server includes a database in which setting information of the electric appliances connected to the network, information of the network or the like is stored. The database is installed with control software for controlling and monitoring the electric appliances and various other software such as an address book, a telephone book, a game and a browser.

The home server also includes an Internet modem for allowing the home server to connect to an external server over the Internet. Through the Internet modem, the home server transmits and receives data to and from a portal server.

The portal server is connected with a home server for controlling a home network system over the Internet and transmits and receives data to and from the home server. Through a web page operated by the portal server, a remote user of the home server can read details such as status information of the home server, stored in the home server, and can transmit control commands to the home server.

As an external server that a home network service provider provides to control a plurality of home servers, the portal server stores the latest version of various software to be installed in the home servers.

If the portal server detects, via data communication with the home servers, that software installed on a home server is an old version, the portal server provides the latest version of the software to the home server, so that the home server automatically downloads and executes or installs the latest version of the software, thereby automatically upgrading the software without manual processes.

In such a manner, the home network system and the method for operating the same according to the present invention not only improves user convenience but also allows the home server to be always installed with the latest version of software, thereby achieving a more stable home network system.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic diagram showing the configuration of a general home network system;

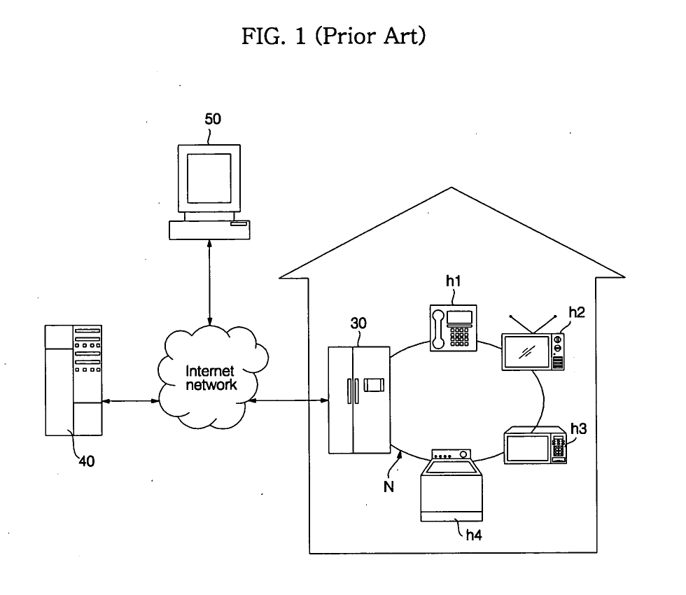

FIG. 2 is a schematic diagram showing the configuration of a home network system according to the present invention;

FIG. 3 is a block diagram showing in detail the configuration of a home server provided in the home network system according to the present invention;

FIG. 4 is a flow chart showing one method for operating the home network system according to the present invention; and

FIG. 5 is a flow chart showing another method for operating the home network system according to the present invention.

### DESCRIPTION OF THE PREFERRED EMBODIMENTS

A home network system and a method for operating the same according to the present invention will now be described with reference to the accompanying drawings.

A plurality of embodiments of the home network system and the method for operating the same are possible according to the present invention, and a most preferred embodiment thereof will be described below. The basic structure of the home network system according to the present invention is substantially the same as that of the conventional home network system described above, and a detailed description thereof will thus be omitted.

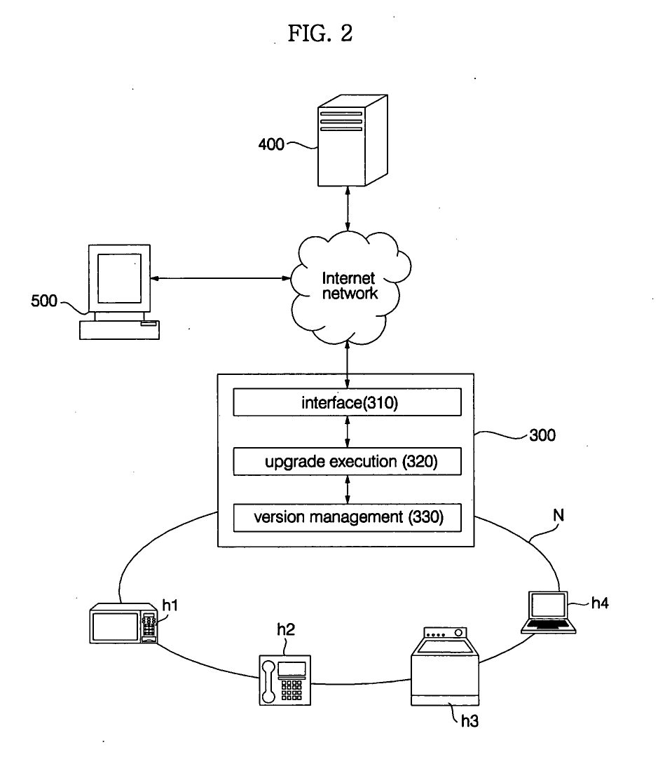

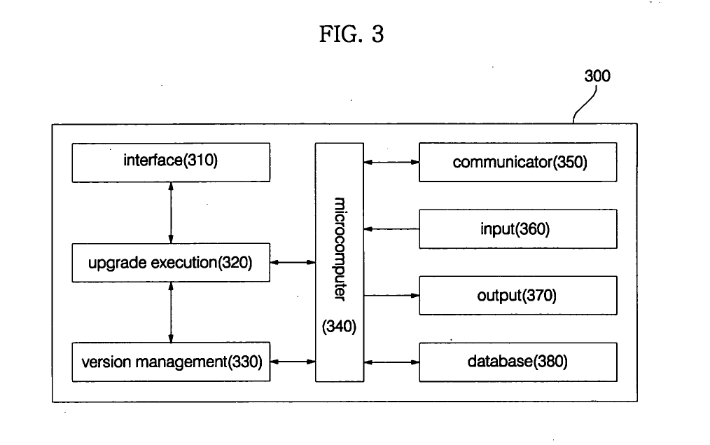

The most preferred embodiment of the present invention will now be described with reference to the accompanying drawings. FIG. 2 is a diagram showing the configuration of a home network system according to the present invention and FIG. 3 is a block diagram showing a home server to which the home network system according to the present invention is applied.

The home server 300 assigns unique IDs to electric appliances connected to a network N to manage the electric appliances. For example, using the IDs, the home server 300 manages plug in/out (or connection of disconnection) of a new/added/dropped electric appliance that is added to or dropped from the network.

As control software, which is embodied as a graphic user interface for improving control convenience, operates, a user can input a control command for controlling a plugged-in or connected electric appliance and monitor operation control states of the electric appliance.

The home server 300 may be any type of electric appliance if it includes a processor, which can process data transmitted to and received from the plurality of electric appliances h1 to h4 connected to the network, and a database in which electric appliance product information is stored. This embodiment illustrates that an Internet refrigerator, which operates 24 hours a day for performing cold storage of food and has a server function for performing state monitoring or operation control of one or more electric appliances installed in a building, is used as the home server 300.

The home server 300 is connected with a portal server 400 over the Internet I. As a management server, the portal server 400 communicates data with a plurality of home servers 300 that manage and control networks N in a plurality of residences, so that the portal server 400 receives network state information from the home servers 300 and also transmits a control command, which a remote user of a home server has input through a web page, to the home server 300.

At the home server 300, a user can input a control command to the home server 300 or confirm operation control states thereof. The user can also remotely input a control command to the home server 300 or confirm operation control states thereof by accessing the web page using a remote control unit 500 that is capable of connecting to the Internet I.

The remote control unit 500 is an Internet terminal, such as a computer, a wireless terminal or a PDA, capable of accessing the web page operated by the portal server 400.

The portal server 400 not only operates the web page for allowing remote control of the home server 300 but also transmits and receives electric appliance information and version information of control software and user software to and from the home server 300 so as to provide services related to software installed on the home server 300, the software including an operating system and various other software for personal information management, memos, a telephone book, a household account book, security management software or the like.

As the home server 300 is connected to the portal server 400, it becomes possible to remotely control the home server 300, and version management and upgrade of the software installed on the home server 300 is performed.

To accomplish this, the home server 300 includes an interface unit 310, an upgrade execution module 320 and a version management module 330, as shown in FIG. 2. The interface unit 310 allows the home server 300 to communicate data with the portal server 400 over the Internet I. The upgrade execution module 320 automatically upgrades software installed on the home server 300 by downloading and executing upgraded software from the portal server 400. The version management module 330 requests software upgrade from the portal server 400 through version management of the software.

The home server 300 also includes a microcomputer 340 and a communication module 350, as shown in FIG. 3. The microcomputer 340 assigns a unique ID to an electric appliance plugged in the network N, and generates an electric appliance information request message to obtain product information of the electric appliance, and also performs operation control and state monitoring of the electric appliance. The communication module 350 communicates data with electric appliances over the network N.

The communication module 350 varies depending on the type of the network N used in the home network system. For example, the network N, to which the electric appliances and the home server 300 are connected, may include a Local Area Network (LAN) typified by Ethernet, a wireless communication network (for example, a wireless LAN) using a high frequency of 2.4 GHz, and a power line communication network in which data communication is performed by carrying data on carriers of high frequencies of several hundreds of kHz to several tens of MHz via a low voltage power line.

Thus, according to the type of the network N, the communication module 350 may be embodied as a wireless communication module, a wired communication module or a power line communication module.

If an electric appliance is newly connected to the network, the microcomputer 340 provided in the home server 300 performs an internal plug-in so as to assign a unique ID for identification of the newly connected electric appliance to the appliance and also to generate and transmit a message requesting the corresponding electric appliance information.

The version management module 330 provided in the home server 300 determines whether it can control the electric appliance with control software currently installed on the home server 300, based on the product information of the newly plugged-in electric appliance.

If the home server 300 does not correctly understand the information of the newly connected electric appliance or if the electric appliance information of the newly connected electric appliance is not interoperable with the control software installed on the home server 300, it is not possible to control the electric appliance even though the electric appliance is physically plugged in the network N.

For this reason, the version management module 330 determines whether the plugged-in electric appliance can be controlled with the currently installed control software.

If it is determined that the electric appliance cannot be controlled, the version management module 330 transmits the product information of the newly connected electric appliance to the portal server 400 and also requests upgrading of the control software to the latest version in which the product information of the newly plugged-in electric appliance is reflected.

Upon receipt of the request message from the home server 300, the portal server 400 transmits a computer file containing the latest version of the control software, which can control the newly connected electric appliance based on the product information thereof received from the home server, to the home server 300, or transmits information of a URL where the latest version of the software can be downloaded to the home server 300.

The computer file containing the latest version of the software received through the interface unit 310 provided in the home server 300 is automatically installed on the home server 300 by the upgrade execution module 320, so as to automatically upgrade the software installed on the home server 300.

On the other hand, in the case where the home server 300 receives the information of the URL, where the software can be downloaded, from the portal server 400, the upgrade execution module 320 automatically connects to a web page corresponding to the URL over the Internet to download and install the software.

As a change in the states of the electric appliances connected to the network N occurs, the portal server 400 receives product information of an electric appliance causing the change, allowing product information of electric appliances stored in the database of the portal server 400 to be equal to the information stored in the home server 300. Thereby, a remote user who is connected to the portal server 400 through the remote control unit 500 can confirm states of all of the electric appliances currently connected to the network N, and can also input control commands.

Product information of the electric appliances h1 to h4, network setting information, control software, software for users or the like are stored in the database 380 of the home server 300.

As an electric appliance is newly or additionally plugged in the network N, the version management module 330 detects a change in the state of the network. Even if there is no change in the state of the network, the version management module 330 performs version management when the system reboots.

As the home server 300 starts up, the version management module 330 requests software version information from the portal server 400, and compares the version of software currently installed on the home server 300 with that received from the portal server 400. If the compared result is that the software being used by the home server 300 is an old version, the version management module 330 requests software version upgrade from the portal server 400.

In addition, if the portal server 400 is provided with new software or the latest version of the software installed on the home server 300, the portal server 400 transmits a message, requesting the home server 300 to upgrade the old version of the currently used software, to the home server 300, thereby informing the home server 300 of the version information of software currently provided in the portal server 400.

In such a manner, the version management module 330 requests automatic upgrade of home server software not only when a change is detected in the plug-in states of the network N but also when the home server 300 starts up or the portal server 400 is provided with new software.

In response to the automatic software upgrade request, the upgrade execution module 320 downloads software from the portal server 400 and installs the downloaded software, thereby performing the automatic software upgrade.

The upgrade performed by the upgrade execution module 320 does not serve to change the entire software package but to change only a corresponding file (for example, a GUI file or a description file), so that the upgrade can be rapidly performed without requiring an annoying reboot of the home server 300.

As a result, the user does not need to visit the web site and search for home server software, and also to perform manual download and installation, thereby improving user convenience, whereas the home server 300 can always be provided with the latest version of software, thereby increasing system stability.

The home server 300 further includes an input unit 360 for receiving control commands of the electric appliances h1 to h4 from the user and an output unit 370 for outputting network state information, software version information and operation control results according to control signals from the microcomputer 340. The input and output units 360 and 370 may be integrated into a touch panel to increase space utilization and user convenience.

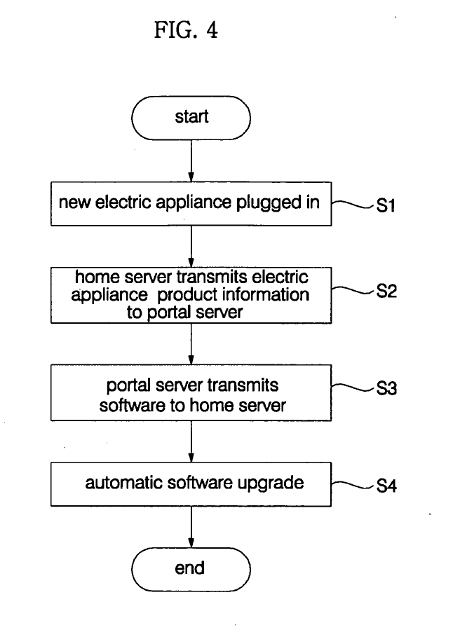

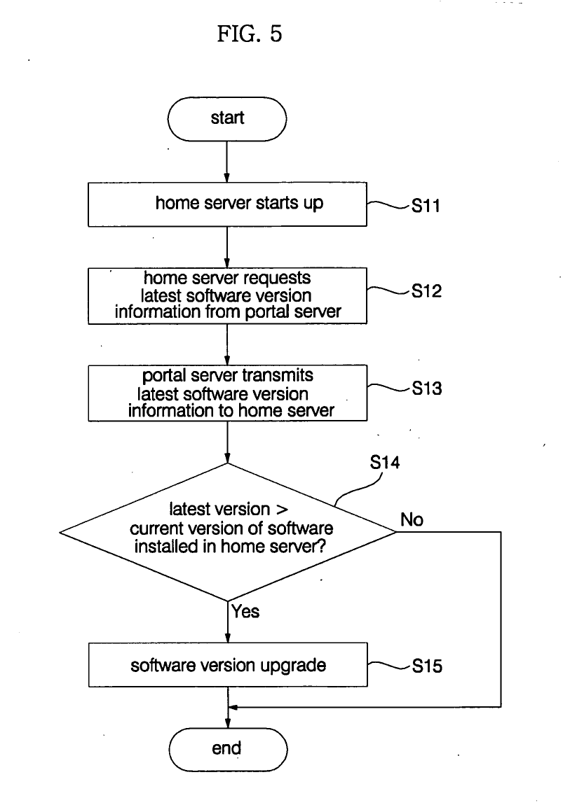

A method for operating the home network system configured as described above according to the present invention will now be described with reference to FIGS. 4 and 5.

FIG. 4 is a flow chart showing how a home network system according to the present invention operates when a home server detects a change in the plug-in state of a network established in a building as an electric appliance is newly or additionally connected to the network. FIG. 5 is a flow chart showing how the home network system according to the present invention operates when the home server reboots.

At step S1, as an electric appliance is newly or additionally connected to the network, the home server detects the plug-in of the electric appliance.

At step S2, the home server obtains product information of the plugged-in electric appliance and transmits the obtained product information to a portal server.

The step S2 may include first to fourth processes. At the first process, the home server assigns a unique ID for network identification to the plugged-in electric appliance. At the second process, the home server obtains electric appliance information from the plugged-in electric appliance. At the third process, the home server determines whether the plugged-in electric appliance can be controlled using control software currently used by the home server, based on the obtained electric appliance information. At the fourth process, depending on the determination of the third process, the home server transmits the electric appliance information and a software upgrade request message to the portal server.

If it is determined at the third process that the plugged-in electric appliance can be controlled using the software already installed in the home server, the home server transmits only the electric appliance information to the portal server, allowing the database of the portal server to be linked with the database of the portal server.

Thereby, the product information of electric appliances stored in the portal server is set equal to the product information of electric appliances stored in the home server, which allows remote control reflecting the current electric appliance connection states.

At step S3, the portal server receives and stores the product information and transmits software for controlling the electric appliance to the home server.

Here, the portal server directly transmits a software file capable of controlling the newly connected electric appliance to the home server or transmits information of a URL providing the software file to the home server.

At step S4, the home server downloads and installs the software, thereby performing automatic software upgrade.

In such a manner, the home server automatically installs the software capable of controlling the newly/additionally connected electric appliance, which eliminates time required to search for, download and install the software, and thus increases user convenience.

Another method for operating the home network system according to the present invention will now be described with reference to FIG. 5.

First, as the home server starts up (S11), the home server transmits a version information request message, requesting latest version information of home server software, to the portal server (S12). The home server software includes an OS, control software for controlling electric appliances, security management software, scheduling software, ect.

Upon receipt of the version information request message, the portal server transmits latest software version information to the home server (S13).

Here, the portal server transmits a latest software file or information of a URL where the software file is downloadable, together with the version information of software currently provided in the portal server, to the home server.

If the software provided in the portal server has a version greater than the software currently installed in the home server, the home server performs software upgrade (S14 and S15).

Here, if the portal server is provided with new software, the portal server transmits a software version upgrade request message to the home server.

Upon receipt of the request message, the home server downloads and installs the new software, thereby performing upgrade of the software (S15).

As apparent from the above description, the present invention provides a home network system and a method for operating the same that have the following features and advantages. When an electric appliance is newly/additionally connected to a network or when new software is released, a home server communicates data with a portal server without manual operation by a user, thereby automatically performing software upgrade, which increases convenience of use.

In addition, since the home server can always be provided with the latest version of software, the home server can fix its program bugs, and it is also possible to provide a home network system having high security and stability.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A home network system comprising:
a plurality of electric appliances connected to a network provided in a building;
a portal server provided to allow the plurality of electric appliances to be remotely controlled from a remote site over the Internet; and
a home server for performing plug-in processing of an electric appliance newly connected to the network and communicating data with the portal server, thereby automatically performing software version upgrade.

2. The system according to claim 1, wherein the home server includes:
an interface unit for communicating data with the portal server over the Internet;
an upgrade execution module for receiving upgraded software from the portal server and performing automatic software upgrade; and
a version management module for requesting software upgrade from the portal server through version management of the software.

3. The system according to claim 2, wherein the home server includes:
a microcomputer for assigning a unique ID to an electric appliance plugged in the network, generating an electric appliance information request message to obtain information of the electric appliance, and performing operation control and state monitoring of the electric appliance; and
a communication module for communicating data with the electric appliance.

4. The system according to claim 3, wherein the home server further includes a database in which electric appliance information and network setting information is stored.

5. The system according to claim 3, wherein the home server further includes:
an input unit for allowing a user to input an electric appliance control command; and
an output unit for outputting network state information, software version information and operation control results according to a control signal from the microcomputer.

6. The system according to claim 3, wherein the communication module is a wireless communication module for transmitting and receiving RF signals.

7. The system according to claim 3, wherein the communication module is a wired communication module for transmitting and receiving signals through a wired LAN.

8. The system according to claim 3, wherein the communication module is a power line communication module for transmitting and receiving signals through a power line.

9. A method for operating a home network system, comprising the steps of:
a) allowing an electric appliance to be plugged in a network provided in a building;
b) by a home server, transmitting product information of the plugged-in electric appliance to a portal server, said home server controlling the network;
c) by the portal server, receiving the product information and transmitting software for controlling the electric appliance to the home server; and
d) by the home server, downloading and installing the software, thereby performing automatic software upgrade.

10. The method according to claim 9, wherein said step b) includes the steps of:
b-1) by the home server, assigning a unique ID to a plugged-in electric appliance;
b-2) obtaining electric appliance information from the electric appliance;
b-3) determining whether the electric appliance can be controlled using home server software, based on the obtained electric appliance information; and
b-4) transmitting the electric appliance information to the portal server according to the determination of said step b-3).

11. The method according to claim 10, wherein said step c) includes the step of transmitting a software file allowing the plugged-in electric appliance to be controllable or information of a URL where the software file is downloadable.

12. A method for operating a home network system, comprising the steps of:
a) transmitting a version information request message to a portal server as a home server operates, said message requesting information of a latest version of home server software;
b) by the portal server, transmitting the information of the latest version to the home server after receiving the version information request message; and
c) performing automatic upgrade of software installed in the home server if the latest version is greater than a version of the software installed in the home server.

13. The method according to claim 12, wherein said step b) includes the step of, by the portal server, transmitting a software file corresponding to the latest version or information of a URL where the software file is downloadable, together with the information of the latest version, to the home server.

14. The method according to claim 12, wherein said step c) includes the step of, by the portal server, transmitting a message, requesting version upgrade of the home server software, to the home server.
